(19) United States
(12) Patent Application Publication
(10) Pub. No.: US 2021/0147024 A1
(43) Pub. Date: May 20, 2021

(54) Bicycle with Bicycle Alarm and Method

(71) Applicant: VANMOOF B.V., Amsterdam (NL)

(72) Inventor: Ties Jonan Midas Carlier, Amsterdam (NL)

(21) Appl. No.: 17/045,414

(22) PCT Filed: Apr. 4, 2019
(86) PCT No.: PCT/NL2019/050205

§ 371 Date: Oct. 5, 2020

(30) Foreign Application Priority Data
Apr. 4, 2018 (NL) 2020718

(51) Int. Cl. B62H 5/20; B62H 5/00; B62J 43/30; B62J 45/20; B62J 6/04; B62J 6/22; B62J 3/14; B60Q 5/00; B62H 5/08; B62J 45/41; B62J 43/13; G01S 19/13; B62M 6/45; G06K 9/00; G10L 17/00; G06F 3/16

(52) U.S. Cl. CPC B62H 5/20; G06K 9/00892; B62J 43/30; B62J 45/20; B62J 6/04; B62J 6/22; B62J 3/14; B60Q 5/001; B62H 5/08; B62J 45/41; B62J 43/13; G01S 19/13; B62M 6/45; G06K 9/00013; G10L 17/00; G06F 3/167; B62H 5/001

(57) ABSTRACT

The present invention relates to a bicycle with bicycle alarm. The bicycle includes a control unit for functional interaction with at least one subsystem of the bicycle. The control unit includes processing means, such as including a processing unit, for processing the at least one status signal, and output means for outputting at least one output signal. The bicycle further includes the at least one subsystem being arranged for providing at least one alarm status signal relating to the bicycle alarm as the at least one status signal, and the processing means are arranged for processing of the alarm status signal relating to the bicycle alarm and providing at least an alarm output signal as the at least one output signal. The alarm output signal is a signal for providing an alarm signal for an audible alarm, an alarm signal for a visible alarm and/or an alarm signal for distribution via a network connection, such as a network connection for short-range, a network connection for a local range, or a network connection via a cellular or mobile network.

### CROSS-REFERENCE TO RELATED APPLICATIONS

This application is the United States national phase of International Application No. PCT/NL2019/050205 filed Apr. 4, 2019, and claims priority to The Netherlands Patent Application No. 2020718 filed Apr. 4, 2018, the disclosures of which are hereby incorporated by reference in their entirety.

### BACKGROUND OF THE INVENTION

### Field of the Invention

The present invention relates to a bicycle with bicycle alarm. Furthermore, the present invention relates to a method relating to a bicycle with bicycle alarm.

### Description of Related Art

It is known to perform a location determination relating to the location of the bicycle after discovery of removal a vehicle, such as a bicycle, from a server in communication with the bicycle. With this, it has been successfully possible to retrieve stolen bicycles by means of a GPS module and a data connection by means of a GSM module. However, the present inventor had the wish to improve such prior art.

### SUMMARY OF THE INVENTION

To this end, the present invention provides a bicycle with bicycle alarm, the bicycle comprising:

a tube assembly comprising a frame with mutually fixed tube elements and movable tube elements, such as steering tube and a handlebar,

at least one subsystem of the bicycle for providing of a respective function to the bicycle,

a control unit for functional interaction with the at least one subsystem of the bicycle, of the control unit comprising:
receiving means for receiving of at least one status signal of the at least one subsystem,
processing means, such as comprising a processing unit, for processing of the at least one status signal, and
output means for outputting of at least one output signal, the bicycle further comprising:

a power supply, such as a battery, for providing of power to the control unit and further preferably to the at least one subsystem, wherein:

the at least one subsystem being arranged for providing of at least one alarm status signal relating to the bicycle alarm as the at least one status signal,

the processing means are arranged for processing of the alarm status signal relating to the bicycle alarm and providing of at least an alarm output signal as the at least one output signal, and wherein:

the alarm output signal the is a signal for providing of an alarm signal for an audible alarm, an alarm signal for a visible alarm and/or an alarm signal for distribution via a network connection, such as a network connection for short-range, a network connection for a local range, or a network connection via a cellular or mobile network.

It is a first important advantage of such a bicycle with bicycle alarm, wherein the bicycle alarm preferably is a function of the control unit, that an alarm output signal may be generated and that the same generates the alarm output signal or can generate the alarm output signal, that by the bicycle alarm at the moment of an attempt of removal of the bicycle. Generating such an alarm output signal based on status signals of at least one of the at least one subsystem provides therefore has direct advantage in activation of the bicycle alarm based thereon. Because of this, it becomes possible that the removal itself is prevented, instead that the bicycle needs to be retrieved according to the prior art.

Preventing of the removal happens at the location for example by the audible and/or visible alarm that is output by the sent subsystem or the lighting subsystem. By this, the remover is startled, preferably already with the first touch of the bicycle. Possible persons that are present in the direct vicinity are alarmed by the sound and/or light signals. Furthermore, the possibility is provided that data relating to the alarm or sent to and subsequently received by a remote server and/or a remote mobile phone, tablet, and/or PC of the user, of a known person. According to an alternative wording, the control system or the processing means thereof determines whether at least one alarm condition, such as deterrence alarm condition for giving of a deterrence alarm signal or a removal alarm condition for giving of a removal alarm signal as alarming alarm signal for the purpose of outputting of the at least one alarm status signal. According to further preferred embodiments, the deterring alarm condition preferably serves the purpose of determining of a potential remover or stealer and serves the removal alarm condition the purpose of providing of loud alarm signals, light signals and/or providing alarm via a network to an alarm server. According to a first preferred embodiment, one of the at least one subsystem comprises a bicycle lock, comprising a sensor for providing of a lock status signal relating to the status of a bicycle lock for the purpose of the alarm to the control unit. Because of this, it advantageously becomes possible to take into account the fact that the user has had the intention to prevent displacement of the bicycle by application of the bicycle lock.

Further preferably, one of the at least one subsystem comprises a contact lock or contact lock function for switching off the control unit or a drive parts thereof between a switched on and a switched off state. Also such a blocking feature or function advantageously provides the possibility to take into account the fact that the user has had to the purpose of preventing this placement of the bicycle by application thereof.

According to a further preferred embodiment, one of the at least one subsystem is a lighting subsystem comprising at least one lighting element for outputting of the visible alarm, wherein preferably the at least one lighting element comprises a front light or a rear light of the bicycle. Such lighting elements advantageously provide an alarming for application in combination with the bicycle alarm. To this end, for example the front light, rear light or a display of the bicycle are usable.

According to a further preferred embodiment, the at least one subsystem comprises a network communication subsystem comprising communication means for communicating via a wireless network connection such as a connection for short-range, such as Bluetooth; a connection via a cellular network or telephone network, such as GSM, 3G, 4G or 5G; or a local connection, such as a Wi-Fi connection. The connection for short-range is preferably used for communication with a network device, such as a mobile phone, of the rightful user of the bicycle. A connection via the cellular network or telephone network is preferably used for communicating with a server or alarm server and/or location determination of the bicycle. A local network connection, such as Wi-Fi is further preferably used for location determination of the bicycle and/or for community gating with the server or alarm server.

According to a further preferred embodiment, the at least one subsystem comprises an operating member, such as a bell button or horn button or an assembly of buttons, for providing user input to the control unit. With this, the bicycle or the control unit thereof is directly operable from the operating member. With this, it is advantageously achieved that for example the alarm can be switched off or the alarm condition can be switched off by means of operating via the operating member. This is at for example especially advantageous in case of loss or battery depletion of the mobile phone of the user of the bicycle. Alternatively, a touchscreen is provided as operating member. According to a further preferred embodiment, the control unit, at least one of the at least one subsystem and/or the power supply is arranged in the tube assembly. With this, a high degree of operating reliability is realized by a good protection of such components.

According to a further preferred embodiment, the control unit, at least one of the at least one subsystem and/or the power supply is arranged in a cassette, wherein the cassette is preferably arrangeable in the tube assembly, further preferably in the top tube. By means of such a cassette, preferably in tube shape, a combination of components is arrangeable in simple manner in a tube of the frame of the bicycle. A further advantage is that for the purpose of repairs of a component such a cassette is removable or mountable in simple manner. With this, maintenance is advantageously performable.

According to a further preferred embodiment one of the at least one subsystem comprises an operating button that is preferably arranged in or at the handlebar, arranged for providing of an operating signal, such as for the purpose of an operation of the bicycle alarm or a bell function or horn function, to the control unit. With this, it is realized that several functions are operable by means of one operating button of the control unit. With this, it is realized that by means of one operating button several functions are operable by means of the control unit. Further preferably, one or more of the following subsystems are lockable or may be switched off: functioning of the bicycle, a mechanical lock, a contact lock function or a contact lock for the control unit and/or an electrical drive motor of the bicycle, further preferably wherein the lock, contact lock function and/or the contact lock is arranged in the tube assembly, arranged for providing of a status signal, such as for the purpose of the alarm, to the control unit.

Further preferably one of the at least one subsystems is an alternator, such as a front wheel alternator, such as a hub alternator, arranged for providing of a status signal, such as an alternator status signal, such as for the purpose of the alarm, to the control unit.

Further preferably, the at least one subsystem comprises a front light and/or a rear light, preferably wherein the front light and/or the rear light is arranged in respective head ends of a top tube as part of the tube assembly, arranged for outputting of at least one of the at least one alarm output signal.

According to a further preferred embodiment, one of the at least one subsystem comprises a G force sensor or a motion sensor, preferably arranged in the tube assembly, further preferably in the cassette, arranged for providing of a motion status signal, such as for the purpose of the alarm, to the control unit.

Further preferably, one of the at least one subsystem comprises a charging connector, for connecting with the power supply, preferably comprising a USB connector and/or a coupling with a drive battery of the bicycle.

Further preferably, one of the at least one subsystem comprises a drive battery, preferably arranged in a tube element, and a drive motor for driving of the bicycle, arranged for providing of a battery status signal, such as for the purpose of the alarm, to the control unit. With this, it is advantageously achieved that a feedback or alarm status adjustment is realizable based on the battery status signal.

According to a further preferred embodiment, one of the at least one subsystem comprises a system for processing and/or storing of sound signals. A considered advantage of such preferred embodiment is that personalized alarm sound signals are usable, may be processed and may be stored. Because of this, it is further preferably achieved to modify such alarm sound signals by means of a firmware update our software updates related to the control unit. Alternatively, it is hereby possible that the user adds own sound files, processes and stores these such as by means of the network connection for short-range or local range, such as by means of an application on a mobile phone or a file transfer.

According to a further preferred embodiment, the at least one subsystem comprises a light sensor, preferably arranged for detecting ambient light, arranged for providing of a status signal, such as for the purpose of the alarm, to the control unit, wherein further preferably the light sensor is arranged in a front light or a rear light of the bicycle. Further preferably, the at least one subsystem comprises a temperature sensor, preferably arranged for detecting an ambient temperature, arranged for providing of a status signal, such as for the purpose of the alarm, to the control unit.

According to a further preferred embodiment, one of the at least one subsystem comprises a GPS receiver, arranged for providing of a status signal, such as for the purpose of the alarm, to the control unit. A further considered location determination is the location determination via a mobile telephone network by means of the module for mobile telephony or data transfer received relevant information from masts within reach. By means of such location determinations, the position of the bicycle is determinable in a way that it is retrievable. The location determination information is there to preferably via said server relayed to an application, such as functioning on a mobile telephone or computer, from a rightful user. Alternatively, a one-on-one connection, such as a peer connection, is provided between the bicycle and the application of the rightful user. For the purpose of mutual reachability, use of a notification message, such as via SMS or push notification is provided.

According to an alternative preferred embodiment, the bicycle comprises a microphone for providing of an ambient sound signal to the control unit for recording or transmitting thereof. With this, it is preferably achieved that such ambient sounds are usable with securing the bicycle. Recorded ambient sounds can provide information relating to a remover or his or her voice. Furthermore, recording of ambient sounds provides the possibility of providing instructions to the control unit of the bicycle.

Further preferably, the bicycle comprises processing means for detecting of the presence of sound, preferably comprising processing means for recording of sound in the form of a sound signal in case of an alarm condition, further preferably comprising determining means for determining of parameters of the sound signal, further preferably comprising compression means for compression of the sound signal for storing thereof or transferring thereof to a server. By means of the determined parameters, it is for example determinable whether an ambient sound fragment is to be stored in a memory or set to the server. The parameters related to for example a time parameter relating to an alarm indication such as based on a motion status of the bicycle such as when the lock status signal of the bicycle indicates that the lock is in the closed state or a contact lock or contact function is switched off. A further parameter is for example the recognition of speech sounds or sound after a prolonged silence.

According to a further preferred embodiment, the bicycle comprises a biometric sensor embodied in speech analysis means for recognizing speech and/or a unique voice, such as that of a rightful owner of the bicycle, from the sound signal preferably for the purpose of assembling a speech status signal. With this, it is achieved that the rightful user of the bicycle is recognizable as such. Based on a recognition based on the speech, unlocking of the lock is provided, such as by means of providing of an en bloc signal from the control unit to the lock.

Further preferably, the bicycle comprises a speech analysis unit for recognizing speech instructions as operating instructions for operating of the bicycle or the control unit thereof from the sound signal. By means of such speech instruction, for instance a contact lock function is controllable for switching on and switching off of controlling of the drive motor. Alternatively, all user interface functions of the bicycle may be switched of from the control unit. With this, the alarm may preferably be switched on by means of the same or a further speech instruction.

Further preferably, the bicycle comprises a biometric sensor, preferably a fingerprint sensor for providing a biometric sensor status signal. A preferred application of such a biometric sensor is switching on of the contact lock function and switching off of the alarm, at least the transfer of the alarm from an alarm status to a free state.

A further aspect according to the present invention relates to a method for providing an alarm from a bicycle, preferably by means of an alarm according to one or more of the preceding claims, comprising steps of:

receiving of at least one status signal by the control unit from one of the at least one subsystem, preferably for the purpose of the bicycle alarm,

assembling of at least one output signal relating to the bicycle alarm by the control unit based on the at least one status signal,

providing of the output signal relating to the alarm to a sound subsystem in case the output signal relates to an alarm signal for an audible alarm, to a lighting subsystem in case the output signal relates to an alarm signal for a visible alarm and/or to a network communication subsystem in case the output signal relates to an alarm signal for a tracking alarm. By means of this aspect, advantages are achieved as indicated in combination with other aspects according to the present invention.

According to a preferred embodiment, the alarm signal relates to an initial alarm signal or an alarming alarm signal. The initial alarm signal, also indicated as the tutoring alarm signal, is given the pending of a motion signal of the motion sensor to warn a person that touches and somewhat moves the bicycle. The alarming alarm signal, also called removal alarm signal, serves the purpose of a clear alarm to the environment that the moving bicycle is being taken while alarming. This is clearly especially noticeable when one or both wheels are blocked against rotating and therefore the bicycle is being taken while being lifted. The parameters of the motion signal based on which the control unit determines to give the initial alarm signal or the alarming alarm signal are preferably determinable or adjustable. Further preferably, the method comprises steps for set receiving of a status signal from a motion sensor.

According to a further preferred embodiment, the method comprises steps for receiving a status signal from a lock function, such as a contact lock function or a mechanical wheel lock, arranged for providing of a status signal relating to an alarm to the control unit. Further preferably and advantageously, such that the signals are suitable inputs for the control unit to determine whether an alarm sound is to be given. In case of the presence of a physical lock with a lock center, the lock sensor provides this lock status signal for the purpose of such a determination. In case of a contact lock function, such as initiated from an application on a telephone or an actuator on the bicycle, this function provides the contact lock signal for the purpose of such a determination.

Further preferably, the method comprises steps of periodically, continuously or on request via a communication network from a server and/or a device of the user performing of a localization of the bicycle. By means of such a location determination, the bicycle is continuously traceable, both after removal and after parking.

Further preferably, the method comprises steps of receiving a status signal or a power signal from an alternator. With this, it is determinable whether a wheel that drives the alternator rotates relative to the bicycle. Further preferably, it is determinable how fast it will rotates. Such a determination is usable in combination with for instance a lock status for the purpose of determining whether an alarming alarm signal is to be given.

According to a further preferred embodiment, steps for switching off of the contact lock function are provided, such as for the purpose of a motor function of a drive motor. With this, it is advantageously realized that based on the receiving of status signals leading to a determination that an alarm condition is to be switched on or has to be switched on the contact lock function is switched off such that the drive motor is no longer provided with energy from a drive battery. In case for example the motion sensor and/or the alternator sensor indicated no movement during a prolonged time, advantageously preferably in the contact lock function is switched of and/or the alarm condition is switched on.

Further preferably, the method comprises steps for switching on of an energy saving mode. In case for example the motion sensor or an alternator sensor indicates motionless for a deterrent time period, switching on of the energy saving mode is preferably realized.

For the purpose of retrieving of a lost bicycle, the method further preferably comprises steps for receiving of signals of other bicycles with bicycle alarm for providing of a location determination, preferably mutually. To this end, the network connectivity for a short distance such as Bluetooth function is applied. In case too bicycles are visible relative to one another, a mutual distance of for example maximally 30 m is to be considered. In combination with knowledge of the absolute location of at least one of both bicycles at said point in time is thereby also the location of the other bicycle determinable.

### BRIEF DESCRIPTION OF THE DRAWINGS

Further advantages, features and details of the present invention will be further elucidated on the basis of a description of one or more preferred embodiments with reference to the accompanying figures. Similar yet not necessarily identical parts of different preferred embodiments may be indicated with the same reference numerals.

FIG. 1 relates to a schematic representation of subsystems of a bicycle with feedback according to a preferred embodiment according to the present invention.

FIG. 2 relates to a schematic, exploded, representation of a cassette for arrangement thereof in a tube element according to a preferred embodiment according to the present invention.

FIG. 3 relates to a schematic representation of part of a tube assembly with their in a cassette and several subsystems according to a preferred embodiment according to the present invention.

FIG. 4 relates to a flowchart of a preferred embodiment according to the present invention.

### DESCRIPTION OF THE INVENTION

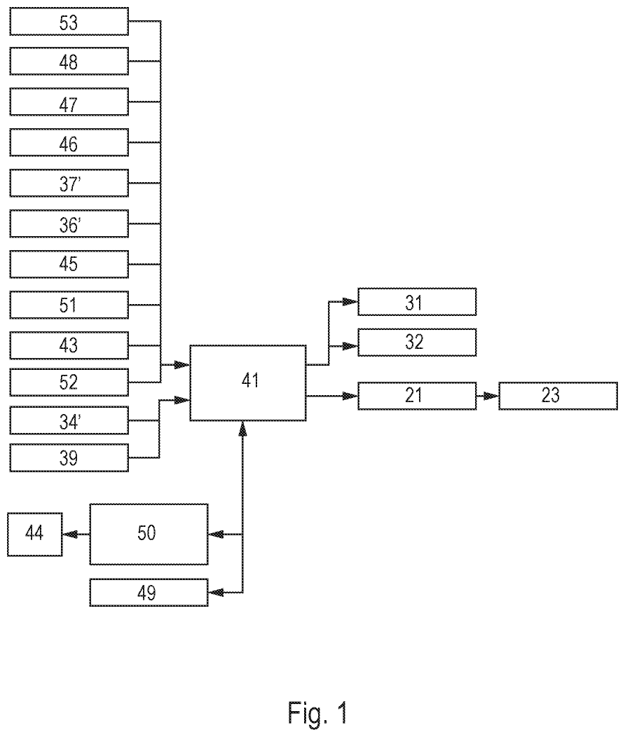

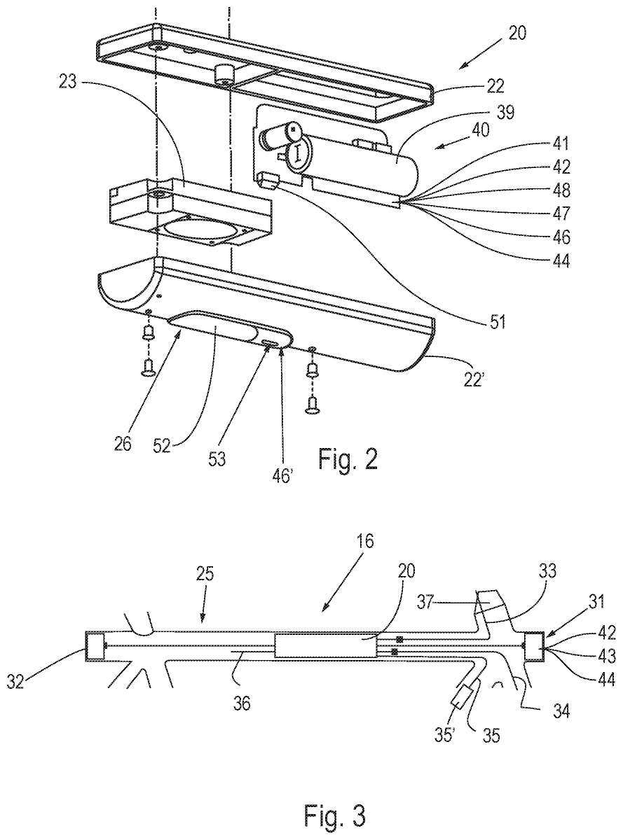

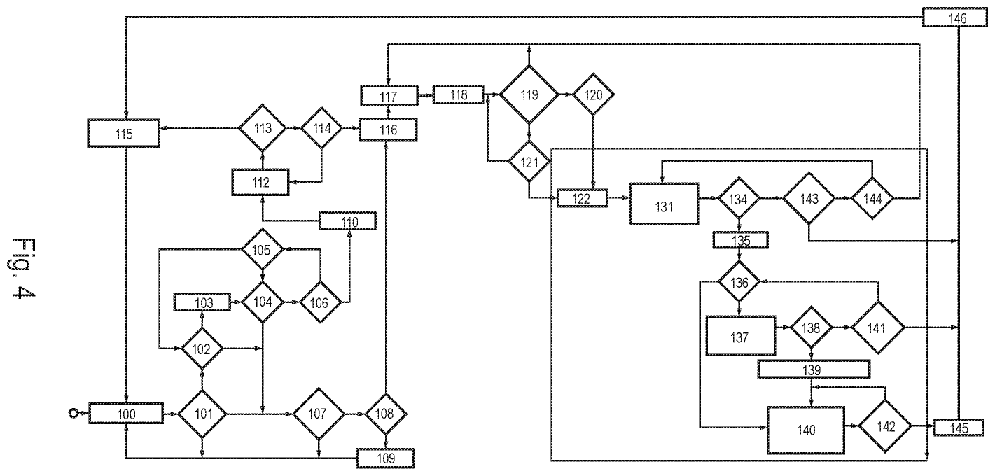

A first preferred embodiment (FIG. 1) according to the present invention relates to a bicycle with bicycle alarm 1, of which a part of a tube assembly 10 thereof is shown in FIG. 3. The bicycle comprises a cassette 20 with their in a control unit 40. A part of the subsystems is arranged in the cassette 20 or in the control unit 40 thereof.

The cassette is built from two shell part, a bottom shell part 22′ and a top shell part 22. The loudspeaker 23 is arranged in the cassette as well as the control unit 40 of the bicycle.

An important advantage of the present invention is that by means of the loudspeaker 23 a sound feedback is provided for several functions of the bicycle and/or several operations of the user. Advantages thereof, that are further elucidated below by means of the description of respective elements of the bicycle, comprise a sound feedback when the user switches off the contact lock function or a physical lock, therewith activating a lock sensor; switching on or off of the light; moving of the bicycle while it is locked and the lock sensor is active, or when the contact lock function is switched off; plugging in or removing a charge cable in the USB port; confirming the speaking of a speech instruction as being received correctly; receiving of a Bluetooth signal of a mobile phone of a user or of a further Bluetooth device of a user, preferably which was preregistered or known to the bicycle; outputting of an alarm sound in case of an alarm condition of the bicycle; a sound feedback when the battery falls under a predetermined threshold charge.

The underside of the bottom shell parts 22′ has a curved surface for fitting within and also curved inner surface of top tube 25 of the bicycle. And optionally extending part of the bottom surface of shell part 22′ is arrangeable within a similarly shaped opening at the underside of the tube. Because of this, extending part 26 is free relative to the outside air for letting sound from the loudspeaker through a grid or openings. Furthermore, in a variant, a microphone 52 is provided for registering of sound from the outside of the bicycle. Furthermore, a fingerprint sensor 53 is provided for registering of a fingerprint of a user. In the present preferred embodiment, the fingerprint sensor 53 is provided in this extending part 26 of the shell part. Alternatively, such a fingerprint scanner is provided under or at the underside of the settle, or at the handlebar.

Depending on the embodiment, the control unit 40 comprises one or more of the following parts, a central processing unit, a battery 42, a temperature sensor 48, a motion sensor 47, a light sensor 46 receiving light through an opening in the tube, a Bluetooth sender receiver 49, a sender receiver 54 communication with mobile networks, such as 2G, 3G, 4G, 5G networks, preferably embodied as an NB-Iot of Cat-M1 module, an antenna 44, a sound processing module 45, and/or a sound amplifier 21 coupled to the loudspeaker 23. An alternative for the battery 42 is coupling with a drive battery 35′ in case of a bicycle with a drive motor. Alternatively, the battery 42 is chargeable from the alternator and/or from the optional drive battery when installed.

An exemplary provided subsystem relates to a temperature sensor 48 for providing of a status signal comprising a temperature reading from the temperature sensor 48. A further subsystem relates to a gravity sensor or G force sensor 47. By means of such G force sensor 47, a status signal is provided with respect to a movement of the bicycle. This status signal is of importance for determining whether the bicycle moves while it is not supposed to be moving, such when it is locked or when a contact lock function of the bicycle means that the bicycle is supposed to be switched off.

The light sensor 48 provides as status signal the amount of incident light. With this, it may be determined whether the bicycle is present in a light or dark environment. The bell button or horn button 37′ is connected by means of the cable 37 with the control unit. A status signal of the bell button or the horn button provides an operating signal of the user. With this, the user can switch off the alarm function by means of inputting of a predetermined code. It is furthermore provided to provide a bell signal or a horn signal by means of the loudspeaker 22.

The lock sensor 36's connected with the control unit by means of the cable 36. The lock sensor provides the condition of the lock by means of the status signal. To this end, the lock sensor is preferably embodied as a switch that is switchable by means of a mechanical element of the lock. Alternatively, it is provided that a contact lock status of the control system is applied in order to determine whether the alarm needs to be activated. Preferably in combination with information from the motion sensor, it is determined to this and that an initial alarm or a general alarm is to be given by means of sounds, light and/or signals by the network module.

A sound module 45 is provided for storage of signals for specific sounds. An initial alarm is preferably given by means of a sound that conveys a warning function, but that is not necessarily suitable for conveying an alarm over large distance. A general or alarming alarm is preferably given by means of a sound that is suitable for an alarming function, by means of the human hearing, over a larger distance, such as over several meters, to several dozens of meters, preferably several hundreds of meters. Furthermore, it is provided by means of the sound module 45 that the user of the bicycle can transfer personal feedback sounds to the sound module for outputting thereof in combination with a specific status signal. In this way, it is provided that the user can output a personalized bell sound from the loudspeaker when pressing the bell button or a predetermined code on the bell button.

A USB connector 51, such as a micro USB connector and/or a USB type C connector, is provided for a charging of the battery 39. The battery 39 is provided for provisioning the control unit with electrical energy as well as thereto coupled subsystems. The USB connector 51 serves the purpose of one of the possibilities to charge the same. Alternatively, in case the bicycle is an electrically driven bicycle or a bicycle with an electric assisting motor, it is provided that the battery is charged from a drive battery 35′ by means of a connecting cable 35. A further charging provision with respect to the battery 39 relates to charging by means of an alternator 34′ coupled by means of cable 34.

A network connection module 50 is provided for having a connection with a cellular telephone network. With this, the control unit is connected with external systems, such as an external server or a device of a user connectable with for instance the Internet, such as a mobile phone or computer.

A Bluetooth connection module 49 is provided for providing a short distance connection with a mobile telephone of a user. With this, the user operates several functions of the bicycle, such as the contact lock function. When the bicycle is in a locked status, the user sends a signal from the mobile telephone to the bicycle that the bicycle is to be brought from the locked status to an operational status. With this, the contact lock function is operated from the mobile phone of the user. This is either provided as an automatic function, such that the telephone and the bicycle automatically connect by means of the Bluetooth connection in order to switch the bicycle to the operational status based on the presence of the telephone. Alternatively, the user can activate this by means of an operation on the mobile telephone, such as by means of inputting a code.

According to a preferred embodiment, the GPS module 43 is separately or in combination with the module 54 mobile communication usable for location the termination of the bicycle.

The front light 31 and the rear light 32 are controllable from the control unit 40 for the purpose of switching on and switching off.

In relation to the FIGS. 4-7, it is provided that it is first determined whether the alarm is switched on. If this is not the case, switching on of a lock function such as a contact lock function or a mechanical lock function is monitored. In case a lock function is switched on, the alarm is switched on. In case the motion sensor detects a motion, the degree and/or duration of the motion is monitored as soon at a threshold is reached, such as 2 seconds, the support of the motor is switched off. In case there lock function is switched off, the alarm is also switched off. However, in case the lock function is not switched off, and initial alarm is given by means of a warning signal for short distance, and/or light signals, such that for short distance, it is indicated that the bicycle is a bicycle with alarm function.

In case the movement continues for the duration of a predetermined time period, such as 30 or 60 seconds, a general alarm is given by means of a loud alarm signal for the bigger distance further than several meters. Also, a signal, preferably also comprising a tracking signal is transferred to a remote server, and/or a mobile telephone of the user. In case in switching off of the contact lock function or mechanical lock function from preferably the mobile phone of the user does not happen, after a further predetermined time, an energy saving mode is switched on in which preferably the lighting function is limited. Also, after a predetermined time. The sound alarm is switched off and further transferred to a predetermined pattern of sending of tracking signals to the server and/or the user. Also, from the user and/or the server, a signal may be sent to the bicycle or the control unit thereof for retrieving an actual position.

In FIG. 4 the following is shown in greater detail. The method begins in step 100 in which the alarm is switched off. In step 101, a check is being performed with regard to the settings of the alarm. In case the alarm is switched off, the method returns in step 100. In case the alarm is set to manual, in step 107 it is checked whether the bell button 37′ (not shown) is pressed with a long press. In case this is not the case, the method returns in step 100. In case in step 107, the bell button is pressed with a long press, the method proceeds in step 108 with a check whether the alternator speed is zero. In case the alternator speed is not zero, a warning sound is given in step 109. In case the alternator speed is zero, in step 116, a feedback sound is given and in step 117, the alarm is switched on. After switching on of the alarm, it is, based on a timer that is reset in step 118, determined in step 119 whether the motion sensor or alternator gives a signal, which means whether the motion sensor detects that the bicycle is in motion or that the alternator, as present in the front wheel, is rotated. If this is determined in step 121 to be the case for longer than 2 seconds, in step 122, the timer is reset and the alarm is switched on in the active mode and with a friendly signaling in step 131, such as a deterring alarm signal. The state is maintained during 2 minutes in step 134. Subsequently, in step 135, a timer is reset and in step 136, it is determined whether the battery level is above a threshold of for example 31%. If this is the case, the alarm switches to an active mode to with a disturbing signaling, such as the removal alarm signal and for example blinking lights in step 137. In case this is maintained longer than one minute, in step 138, then in step 139, a message is sent to the server via the module for mobile communication. Subsequently, the alarm is switched to an active mode 3 in which energy is saved by switching off of light and sound, and a transition is made to the tracking mode wherein the location of the bicycle is determined at distinct times and sent to the server. In case it is determined in step 136 that the battery level is lower than the threshold of for example 31%, a direct transition is performed from the active mode one 2 active mode 3. In case at any time the alarm is switched off, and this is determined in step 146, tracking of the location of the bicycle is stopped in step 145 and the alarm is switched off in step 146.

In case it is determined in step 134, that the time is less than the exemplary threshold value of 2 minutes and in step 143 it is determined that the alarm is switched off, then the method proceeds in step 146. In case in step 143, it is not determined that the alarm is switched off, it is determined in step 144 whether the alarm sensor of the alternator or motion sensor is still active and the method proceeds in step 131. In case it is determined in step 144 and that the alarm detection of the alternator or the motion sensor is no longer active, the method proceeds in step 117. In case the bicycle is subsequently renewedly brought in motion, the steps from step 117 will repeat. In case it is determined in step 138 within the time of one minute in combination with step 141, that the alarm is switched off, the method proceeds in step 146, wherein when it is determined in step 141 that the alarm is not switched on, the method proceeds in step 136.

With this, an operational example is described in relation to FIG. 4 of the functioning of the control unit when receiving operating signals and performing the alarm function.

According to preferred embodiments according to the present invention, a bicycle is provided with the capability of giving a feedback to occurrences by means of sound, which occurrences comprise operations of the user of the bicycle and operational feedback sounds related to states of the control unit of the bicycle and thereto coupled subsystems. Such feedback sounds related to bell sounds; warning sounds relating to an alarm function such as sounds 40 during and alarming alarm sounds; and operational feedback sounds such as a general positive feedback signal that is fed back such as a confirmation, a generally negative feedback signal such as indicating the opposite of a confirmation, a switch on the sound, such as of the control unit or a contact lock function, a switch of sound or standby confirmation, a switch on confirmation of the alarm, a switch of confirmation of the alarm, a confirmation sound of a lock switching to a locked state, a confirmation sound of a lock that is being unlocked, a sound of movement for moving through a menu, or a confirmation sound with inputting of a pin code for, for instance manually switching off of an alarm.

The present invention is described in the foregoing on the basis of preferred embodiments. Different aspects of different embodiments are expressly considered disclosed in combination with each other and in all combinations that on the basis of this document, when read by a skilled person of the area of skill, fall within the scope of the invention or are deemed to be read with the disclosure of this document. Further examples of the priority application are incorporated by means of a reference. These preferred embodiments are not limitative for the scope of protection of this document. The rights sought are defined in the appended claims.

1. A bicycle with bicycle alarm, the bicycle comprising:
a tube assembly comprising a frame with mutually fixed tube elements and movable tube elements, such as a steering tube and a handlebar,
at least one subsystem for providing of -a respective function to the bicycle,
a control unit for functional interaction with the at least one subsystem of the bicycle, the control unit comprising:
receiving means for receiving at least one status signal of the at least one subsystem,
processing means, such as a processing unit, for processing the at least one status signal, and
output means for outputting at least one output signal, the bicycle further comprising:
a power supply, such as a battery, for providing power to the control unit and further preferably to the at least one subsystem, wherein:
the at least one subsystem is arranged for providing at least one alarm status signal relating to the bicycle alarm as the at least one status signal,
the processing means are arranged for processing the alarm status signal relating to the bicycle alarm and providing at least an alarm output signal as the at least one output signal, and wherein:
the alarm output signal is a signal for providing an alarm signal for an audible alarm, an alarm signal for a visible alarm and/or an alarm signal for distribution via a network connection, such as a network connection for short-range, a network connection for a local range, or a network connection via a cellular or mobile network.

2. The bicycle according to claim 1, wherein one of the at least one subsystem comprises a bicycle lock, comprising a lock sensor for providing a lock status signal relating to the status of a bicycle lock for the purpose of the alarm to the control unit.

3. The bicycle according to claim 1, wherein one of the at least one subsystem comprises a contact lock or contact lock function for switching off the control unit or a drive parts thereof between a switched on and a switched off state.

4. The bicycle according to claim 1, wherein one of the at least one subsystem comprises a motion sensor for providing of-a motion sensor status signal.

5. The bicycle according to claim 1, wherein one of the at least one subsystem is a lighting subsystem comprising at least one lighting element for outputting the visible alarm, wherein preferably the at least one lighting element comprises a front light or a rear light of the bicycle.

6. The bicycle according to claim 1, wherein one of the at least one subsystem comprises a network communication subsystem comprising communication means for communicating via a wireless network connection such as a connection for short-range, such as Bluetooth; a connection via a cellular network or telephone network, such as GSM, 3G, 4G or 5G; or a local connection, such as a Wi-Fi connection.

7. The bicycle according to claim 1, wherein one of the at least one subsystem comprises an operating member, such as a bell button or horn button or an assembly of buttons, for providing user input to the control unit.

8. The bicycle according to claim 1, wherein one of the at least one subsystem comprises at least one operating member, such as a touchscreen.

9. The bicycle according to claim 1, wherein one of the at least one subsystem comprises at least one operating member, such as a touchscreen.

10. The bicycle according to claim 1, wherein the control unit, at least one of the at least one subsystem and/or the power supply is arranged in a cassette, wherein the cassette is preferably arrangeable in the tube assembly, further preferably in the top tube.

11. The bicycle according to claim 1, wherein one of the at least one subsystem comprises an operating button that is preferably arranged in or at the handlebar, arranged for providing of an operating signal, such as for the purpose of an operation of the bicycle alarm or a bell function or horn function, to the control unit.

12. The bicycle according to claim 1, wherein one of the at least one subsystem is a sensor relating to the status of a lock locking the functioning of the bicycle, such as a mechanical lock, a contact lock function or a contact lock for the control unit and/or an electrical drive motor of the bicycle, further preferably wherein the lock, the contact lock function and/or the contact lock is arranged in the tube assembly, arranged for providing of a status signal, such as for the purpose of the alarm, to the control unit.

13. The bicycle according to claim 1, wherein one of the at least one subsystem is an alternator, such as a front wheel alternator, such as a hub alternator, arranged for providing a status signal, such as an alternator status signal, such as for the purpose of the alarm, to the control unit.

14. The bicycle according to claim 1, wherein one of the at least one subsystem comprises a front light and/or a rear light, preferably wherein the front light and/or the rear light is arranged in respective head ends of a top tube as part of the tube assembly, arranged for outputting 4-at least one of the at least one alarm output signal.

15. The bicycle according to claim 1, wherein one of the at least one subsystem comprises a G force sensor or a motion sensor, preferably arranged in the tube assembly, further preferably in the cassette, arranged for providing a motion status signal, such as for the purpose of the alarm, to the control unit.

16. The bicycle according to claim 1, wherein one of the at least one subsystem comprises a charging connector, for connecting with the power supply, preferably comprising a USB connector and/or a coupling with a drive battery of the bicycle.

17. The bicycle according to claim 1, wherein one of the at least one subsystem comprises a drive battery, preferably arranged in a tube element, and a drive motor for driving the bicycle, arranged for providing a battery status signal, such as for the purpose of the alarm, to the control unit.

18. The bicycle according to claim 1, wherein one of the at least one subsystem comprises a system for processing and/or storing sound signals.

19. The bicycle according to claim 1, wherein one of the at least one subsystem comprises a light sensor, preferably arranged for detecting ambient light, arranged for providing a status signal, such as for the purpose of the alarm, to the control unit, wherein further preferably the light sensor is arranged in a front light or a rear light of the bicycle.

20. The bicycle according to claim 1, wherein one of the at least one subsystem comprises a temperature sensor, preferably arranged for detecting an ambient temperature, arranged for providing a status signal, such as for the purpose of the alarm, to the control unit.

21. The bicycle according to claim 1, wherein one of the at least one subsystem comprises a GPS receiver, arranged for providing a status signal, such as for the purpose of the alarm, to the control unit.

22. The bicycle according to claim 1, further comprising a microphone for providing an ambient sound signal to the control unit for recording or transmitting thereof.

23. The bicycle according to claim 22, further comprising processing means for detecting the presence of sound, preferably comprising processing means for recording sound in the form of a sound signal in case of an alarm condition, further preferably comprising determining means for determining 4-parameters of the sound signal, further preferably comprising compression means for compression of the sound signal for storing thereof or transferring thereof to a server.

24. The bicycle according to claim 22, further comprising a biometric sensor embodied in speech analysis means for recognizing speech and/or a unique voice, such as that of a rightful owner of the bicycle, from the sound signal preferably for the purpose of assembling a speech status signal.

25. The bicycle according to claim 22, further comprising a speech analysis unit for recognizing speech instructions as operating instructions for operating the bicycle or the control unit thereof from the sound signal.

26. The bicycle according to claim 1, further comprising a biometric sensor, preferably a fingerprint sensor for providing a biometric sensor status signal.

27. A method for providing an alarm from a bicycle, preferably by means of an alarm, comprising steps of:
receiving at least one status signal by a control unit from one of at least one subsystem, preferably for the purpose of the bicycle alarm,
assembling at least one output signal relating to the bicycle alarm by the control unit based on the at least one status signal, and
providing the output signal relating to the alarm to a sound subsystem in case the output signal relates to an alarm signal for an audible alarm, to a lighting subsystem in case the output signal relates to an alarm signal for a visible alarm and/or to a network communication subsystem in case the output signal relates to an alarm signal for a tracking alarm.

28. The method according to claim 27, wherein the alarm signal relates to an initial alarm signal or an alarming alarm signal.

29. The method according to claim 27, further comprising steps for receiving a status signal from a lock function, such as a contact lock function or a mechanical wheel lock, arranged for providing a status signal relating to an alarm to the control unit.

30. The method according to claim 27, further comprising steps of receiving a status signal from a motion sensor.

31. The method according to claim 27, further comprising steps periodically, continuously or on request via a communication network from a server and/or a device of the user performing a localization of the bicycle.

32. The method according to claim 27, further comprising steps of receiving a status signal or a power signal from an alternator.

33. The method according to claim 27, further comprising steps of switching off a contact lock function, such as for the purpose of a motor function of a drive motor.

34. The method according to claim 27, further comprising steps of switching on an energy-saving mode.

35. The method according to comprising steps of receiving signals from other bicycles with bicycle alarm for providing a location determination, preferably mutually.
